(19) United States
(12) Patent Application Publication
(10) Pub. No.: US 2014/0022385 A1
(43) Pub. Date: Jan. 23, 2014

(54) MOBILE COMMUNICATION TERMINAL WITH A FIRE ALARM APPLICATION ABLE TO BE EXECUTED THEREON AND ALSO A FIRE ALARM APPLICATION ABLE TO BE DOWNLOADED FROM AN ONLINE INTERNET STORE PORTAL

(71) Applicant: Martin FISCHER, Buelach (CH)

(72) Inventor: Martin FISCHER, Buelach (CH)

(73) Assignee: SIEMENS AKTIENGESELLSCHAFT, Munich (DE)

(21) Appl. No.: 13/944,953

(22) Filed: Jul. 18, 2013

(30) Foreign Application Priority Data
Jul. 18, 2012 (EP) 12176937.6

(51) Int. Cl. G08B 17/12

(52) U.S. Cl. CPC G08B 17/125
USPC 348/143

(57) ABSTRACT

A smartphone or media player mobile communication terminal features a camera, an output unit, a data memory and a processor connected thereto. The data memory stores applications. The applications are loaded and executed by the processor. A fire alarm application is stored in the data memory, which in response to a user request, is loaded by the processor and executed. The fire alarm application features suitable program elements for analyzing the video image data recorded by the camera in respect of at least one item of information characteristic of fire and, if this information is present, for outputting an alarm via the output unit. The fire alarm application can be downloaded from an online Internet store portal for computer programs and designed for execution on the portable mobile communication terminal.

### CROSS REFERENCE TO RELATED APPLICATIONS

This application claims the benefit of EP12176937, filed on Jul. 18, 2012 with the European Patent Office, the disclosure of which is incorporated herein in its entirety by reference.

### BACKGROUND

The invention relates to a portable mobile communication terminal, especially a smartphone or a media player. The invention also relates to a fire alarm application able to be downloaded from an online Internet store portal.

Portable mobile communication terminals are generally known. These can involve a smartphone such as the iPhone series from Apple, the Galaxy series from Samsung or the Lumia series from Nokia for example. Such communication terminals are also referred to as mobile telephones or cellphones. The portable mobile communication terminals can also involve what are referred to as tablet computers or tablet PCs, such as an iPad from Apple or a Galaxy Tab from Samsung. Furthermore the communication terminals can involve mobile media players, such as the iPod touch series from Apple or the Yepp series from Samsung. These devices are also referred to by the abbreviation PMP for Portable Media Player. The portable mobile communication terminals from Apple mentioned at the start are typically based on an iOS operating system, the devices from Samsung on an Android operating system and the devices from Nokia on a Windows Phone operating system.

Fire alarms are also known from the related art which are referred to as (automatic) fire alarms. They are configured for detection of open fire and/or of smoke and therefore also referred to as flame alarms or smoke alarms. Such fire alarms are typically embodied as point alarms for attachment to the ceiling.

Flame alarms of the above type are provided for detection of open fire with its characteristic modulated emissions, such as by a wavelet analysis or a Fourier analysis for example, and also for output of an alarm in typically less than one second. As regards signal processing, they are attuned to the characteristic flicker frequencies of open fire, i.e. of flames and glowing embers in the infrared range and if necessary in the visible and ultraviolet range. The open fire can be detected for example by means a video camera or by suitable radiation detectors, such as by IR photodetectors for example.

EP 1 762 995 A1 describes a method and a device for detection of smoke by analysis of video images which are recorded by means a video camera. For this purpose the intensity values of the individual pixels are compared with each other in consecutive video images for the occurrence of smoke. If the intensity values are measured which are representative of a brighter image caused by the presence of smoke it is concluded that smoke is present and an alarm is triggered. In this system the direction of movement, the speed of movement, the size and also the speed of propagation of smoke is determined, by the number of pixels with a high intensity value and their change being determined computationally for example. Basically, after determination of an apparent presence of smoke in the moving area the relevant video image range can then be examined for information characteristic of smoke. Such information is seen as the direction of movement and the speed of the smoke, the number of pixels in the video image which describe this movement, the change in brightness and also the change of the colors of the moving smoke.

### SUMMARY

The inventor proposes a fire alarm application stored in a data memory of the camera-supported portable mobile communication terminal, which has an output unit. The data memory is provided inter alia for the storage of items such as applications. At the request of a user, the fire alarm application is loaded and executed by the processor. The fire alarm application has suitable program elements in order to analyze video image data recorded by the digital camera in respect of at least one item of information characteristic for fire and, if said information is present, to output an alarm via the optical and/or acoustic output unit. Current portable mobile communication terminals benefit from the fact that the high computing power available also makes complex and thereby very reliable video analyses possible.

This advantageously makes fire monitoring of a room through a video analysis possible. To do this the user merely needs to select the fire alarm application, start it and align the digital camera of the communication terminal to the room area to be monitored. In the simplest case the communication terminal, such as a smartphone for example, is rested against a wall or against an object such as a book for example. In the event of a fire, i.e. if there has been detection of smoke and/or of open fire, an alarm is sent to the user. This can be done by a suitable alarm tone or via a voice message by a loudspeaker of the communication terminal and/or optically such as for example by a flashing activation of the LEDs provided for the digital camera.

The alarm message can also be output via a wireless data interface of the communication device in the form of a text message, especially as a short message service (“SMS”), to a predetermined telephone number. It can for example contain the text message “fire alarm” or “smoke alarm”.

Naturally the fire alarm application can also have program elements which, on detection of the fire by the digital camera provided for fire monitoring, also allow a photo and/or a video sequence to be recorded. This photo and/or this video sequence can then be stored in the communication terminal and/or transferred via the wireless data interface to a predetermined distant location. The photo can for example be transferred by an MMS (Multimedia Messaging Service) to another communication terminal. As an alternative—like the video sequence as well—it can be transmitted as an e-mail with a photo attachment to a prespecified e-mail account. The video sequence can also be transmitted via further communication applications such as “Whatsapp” or “Skype” for example to another prespecified user.

Especially suitable are also “old” communication terminals for which the contract period with a provider has already expired—such as e.g. after two years—and/or which are technically or functionally no longer attractive. They can advantageously be employed for a low-cost monitoring of objects such as for example an apartment or a holiday home.

A “fire alarm” on such a communication terminal also has the advantage that for example a minimum the safety is guaranteed in “unsafe” hotels, motels or guesthouses. It is precisely in these types of accommodation options that the functional capabilities and reliability of fire alarms systems is often dubious.

It is also especially advantageous that the digital camera of such a smartphone, as well as recording the optical range visible to the eye, also records the near infrared range, i.e. up to a wavelength of around 1000 nm. It is precisely this spectral range that is well suited to the early detection of heat and thus of open fire and smoke.

The data memory of such a communication terminal is typically a non-volatile memory, such as e.g. a flash memory or a hard disk. The flash memory can be a semiconductor memory integrated into the communication terminal. As an alternative or in addition it can be an external memory, which is realized by a digital memory card able to be plugged into the communication terminal, such as e.g. by an SD (Secure Digital) memory card.

Typically these types of communication terminal have a random access memory (RAM) in which at least parts of computer programs, operating system routines, applications and also images, videos, music data and other data are loaded by the processor from the data memory and executed or processed. The random access memory can be embodied as non-volatile or volatile.

An application—also referred to in jargon as an app—and thus also the proposed fire alarm application, is a computer program, i.e. software which is can be executed by the processor in the communication terminal. It also features program elements to enable data communication via the processor to peripheral devices of the communication terminal. In the case of the fire alarm application that is at least the digital camera and if necessary the digital front camera and also one of the output units such as the loudspeaker for example, the white-illuminating LEDs, a vibration alarm or a data interface for output of the alarm.

In accordance with an embodiment, the fire alarm application features suitable program elements for detecting open fire by analysis of characteristic modulated emissions of open fire in the sense of a flame alarm. This advantageously enables known analysis methods and evaluation algorithms from known, reliable and fast-reacting flame alarms and the associated functionality to be transferred to such a mobile communication terminal.

In particular the fire alarm application features suitable program elements for analyzing the modulated emissions of open fire in respect of its characteristic flicker frequency and/or its color spectrum.

In accordance with a further embodiment the fire alarm application features suitable program elements for analyzing at least one moving area in the video image data for determining the direction and the size of the moving area for the possible presence of smoke as a function of at least one item in the information characteristic of smoke. This advantageously enables known analysis methods and evaluation algorithms from known, reliable video smoke alarms and the associated functionality to be transferred to such a mobile communication terminal. Naturally both video-based detection methods for open fire and smoke can be executed in parallel on the processor, such as in two separate processes or in two separate processor cores for example.

In accordance with an embodiment the communication terminal features a light source, especially a white-illuminating LED, which is able to be activated by the processor for at least brief illumination of a recording area lying in front of the camera. In addition the fire alarm application features suitable program elements for switching on the light source at least for a period. This is advantageous for example in darkness or in gloomy conditions if the average brightness in the respective video image is too low, so that a reliable video analysis is no longer possible. Then only the video image data of recorded video images is evaluated, during which the light source is also switched on. As an alternative or in addition a difference between images, i.e. a video image with flash minus a video image without flash, can be formed in order to establish a high-contrast reference image for example.

The fire alarm application can also feature suitable program elements for switching on a background illumination of the touchscreen display for illuminating the room. It can also feature program elements for setting the color of the touchscreen display, such as to red, green, yellow or blue for example. This is because it is known that short wavelengths, such as with blue light for example, allow the detection of smaller particles, while longer wavelengths on the other hand, such as red or dark red light for example, allow the detection of larger particles. If the fire alarm application features suitable program elements for doing this, then by computational evaluation of the ratio of blue scattered light to red scattered light or vice versa, which are scattered in each case by the particles to be detected in relation to the digital camera, a particle size can be detected. This enables a symptom for the presence of smoke with small particle size of typically far less than 1 pm or dust with larger particle size of typically far greater than 1 μm to be determined and output.

In general continuous detection in the sense of a video film, i.e. with an image refresh frequency of 24 Hz and more, is not required for video-based fire monitoring. The image refresh frequency for video-based flame detection should further lie in the range of between 10 and 20 Hz in order to be able to detect the typical flicker frequency of around 6 Hz. It is also conceivable that the detection of the video image data is undertaken with a first lower image refresh frequency in the range of 1 Hz to 10 Hz and that then, on detection of a significant deviation e.g. in two consecutive video images, there is a switch to a second higher image refresh frequency in the range of 24 Hz up to a technically maximum possible image refresh frequency such as e.g. 50 Hz or 100 Hz. For video-based smoke detection it is sufficient however for the video refresh frequency to lie in the range of a few Hertz, such as e.g. between 1 Hz and 5 Hz, or even below this, such as e.g. between 0.1 and 1 Hz.

In accordance with a further embodiment the communication terminal features a data interface. In addition the communication terminal is configured to load applications as well as the fire alarm application via the data interface into the data memory. This can be done for example via a USB interface or via a data interface for connection by cable to an external computer.

In accordance with an especially advantageous embodiment, an operating system, such as e.g. an iOS, Android or a Windows phone operating system, for operating the communication terminal is stored in the data memory. The data interface is configured for online data exchange between the communication terminal and the Internet and/or with an intranet. Stored in the data memory is an application store program, wherein this application store program is designed for loading applications, i.e. “APPs” as well as the fire alarm application from an online Internet store portal via this data interface.

The particular advantage is that each Internet-capable portable mobile communication terminal with camera, i.e. in principle any Internet-capable smartphone and media player, can be “upgraded” to a fire alarm in an extremely simple manner by downloading and if necessary automatically installing the proposed fire alarm “app”.

After the application store program, such as the “App Store” program from Apple on an iPhone or the “Play Store” program from Google for a communication terminal with the Android operating system has been started, the fire alarm application can be selected from a corresponding mostly similarly-named online Internet store portal via the touchscreen and then downloaded as a paid application. After automatic installation or alternatively after a request to the user the fire alarm application is started.

Preferably the data interface is a wireless data interface, especially based on a mobile wireless, WLAN and/or Bluetooth standard. The mobile wireless standard can e.g. be a GSM, UMTS, CDMA or LTE standard. In particular the wireless data transmission is based on an Internet protocol, such as on TCP/IP for example.

Finally the inventor proposed a fire alarm application designed for downloading from an online Internet store portal for computer programs and for execution on such a portable mobile communication terminal, especially for execution on a smartphone or on a media player.

Such a fire alarm application can also feature suitable program elements which make it possible for the “fire alarm” to learn. For this purpose the fire alarm application can feature program elements for adapting the digital camera to the ambient brightness and/or to the ambient contrast. The fire alarm application can also feature a “guide” or “wizard”, which instructs the user on finding a suitable position for setting up the communication terminal.

The fire alarm application can also feature suitable program elements for executing a test mode. Thus the effectiveness of the fire detection can be checked for example, as to whether for example the flame of a cigarette lighter in front of the digital camera or the smoke of a cigarette in front of the digital camera is detected.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a typical smartphone as a portable mobile communication terminal with a fire alarm “app” in accordance with the inventor's proposal executed thereon,

FIG. 2 shows a block diagram of the smartphone in accordance with FIG. 1, with the fire alarm application stored in a data memory,

FIG. 3 shows a side view of the smartphone in accordance with FIG. 1, with a digital camera directed towards an open fire and

FIG. 4 shows a side view of the smartphone in accordance with FIG. 1 with a digital camera directed towards smoke.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

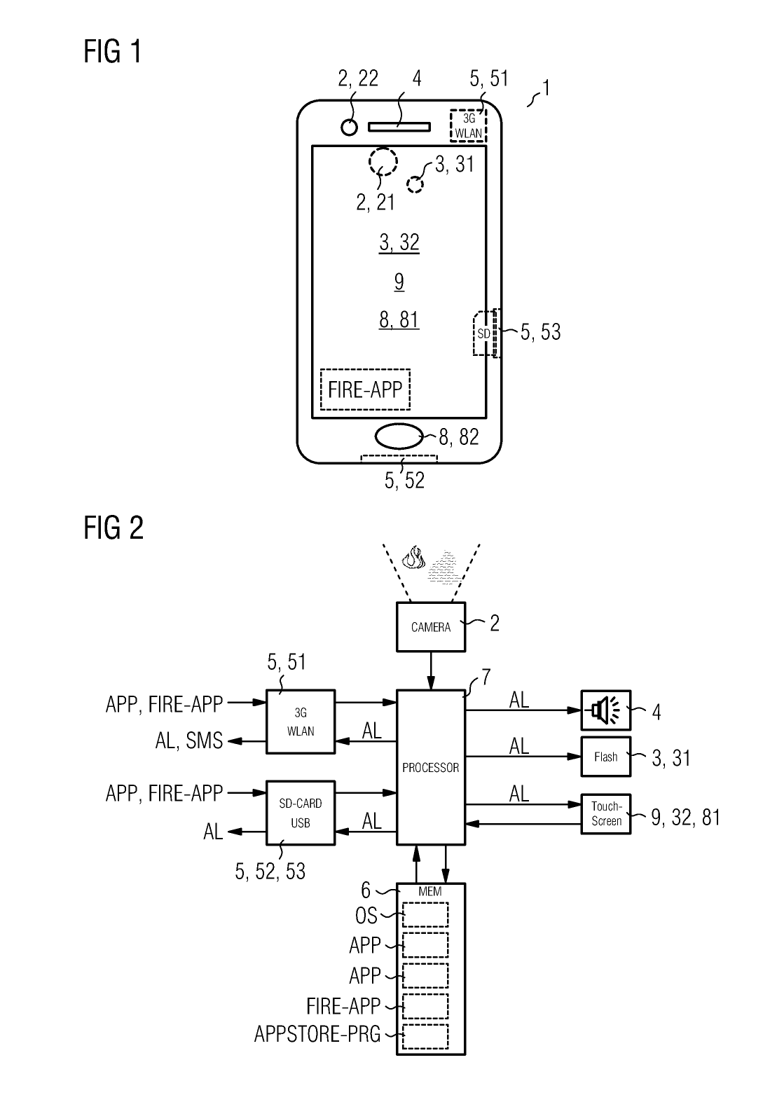

FIG. 1 shows a typical smartphone 1 as a portable mobile communication terminal with a fire alarm “app” FIRE-APP executed thereon in accordance with the inventor's proposal. The smartphone 1 shown features a touch-sensitive display 9, which is also referred to as the touchscreen, on its front side facing towards the observer. The touchscreen features a touch-sensitive transparent user input surface 81 as input unit 8 and a display 32 as output unit 3. Shown in the upper part of the smartphone 1 is a digital front camera, labeled with reference number 22, which is especially designed for video telephony. Labeled with the reference number 4 as an output unit is a loudspeaker for speech output and also for output of call or ring tones. An operating button (input button) 82 can be seen in the lower part.

On the lower side of the smartphone 1 shown a data interface 52 as output unit can also be seen, which is designed for connecting the smartphone 1 to an external computer via a cable. This can also be configured for charging the rechargeable battery and/or for supplying power permanently to the smartphone 1, so that fire monitoring by the communication terminal is possible permanently and without interruption.

Shown as a dashed area in the right-hand part of the smartphone 1 shown is a slot 53 for accepting a digital data memory. In the example of FIG. 1 this is an SD memory card. Shown in the upper right-hand part of the smartphone 1 as a dashed area is an integrated wireless data interface 51 as an output unit 5. This is for example a combined mobile radio/WLAN wireless data interface. Finally, arranged on the rear side of the smartphone 1 shown are a digital camera 21 or camera 2 for recording photos and videos, with a higher image and video quality compared with the front camera 22, as well as a white illuminating LED 31 as output unit. It can be briefly activated as a kind of photo flash.

FIG. 2 shows a block diagram of the smartphone 1 used as an example in FIG. 1 with the fire alarm application FIRE-APP stored in a data memory 6. The central unit is a processor 7, such as an A5 processor from ARM for example. It has data and/or signal connections to the camera 2, to the combined input/output unit 9, i.e. the touchscreen, to the LED flash 31 for the camera 2, to an acoustic output unit 4, to the data interface 5 as output unit and to the data memory 6. The data interface 5 shown comprises a wireless data interface which is based in the example on the 3G and WLAN standard, and two contact-based data interfaces, such as a USB and an SD memory card data interface. Memory blocks are shown as dashed-line areas in the data memory 6 represented as one block, which each occupy a certain memory location in the data memory 6, such as 1 MByte for example. The letters OS designate the memory occupied for the respective operating system used in the smartphone 1. It is typically already factory-installed. The letters APP designate to applications already stored in the data memory 6. Also a fire alarm application FIRE-APP is stored as the next memory block in the data memory 6. Finally an application store program APPSTORE-PRG is also stored as a block in the data memory. This program APPSTORE-PRG is also typically factory-installed. This program APPSTORE-PRG is used for management of the applications obtained via an online store portal for computer programs, the so-called “Apps”. The stored applications APP are loaded by the processor and executed, mostly in response to a user request.

In accordance with the proposal, the fire alarm application FIRE-APP stored in the data memory 6 can be loaded by the processor 7 in response to a user request and executed. This can be done by tapping a corresponding symbol, such as the flame symbol, on the touchscreen for example. The communication terminal thus becomes an communication terminal in or with the function of a fire alarm.

The fire alarm application FIRE-APP here features suitable program elements for analyzing the video image data recorded by the camera 2 in respect of at least one item of information characteristic for fire and, if said information is present, for outputting an alarm AL via the output unit 3, 4, 5. In the example shown the alarm can be given via the loudspeaker unit 4 acoustically, via the flash LED 31, via the display 32 of the touchscreen 9, as a text message SMS (alarm message AL) via the wireless data interface 51 and/or via a computer connected to the smartphone 1 via the USB data interface 52. The selection of the alarm can for example be set in a configuration menu of the fire alarm application FIRE-APP.

In accordance with the invention fire alarm application FIRE-APP is an application designed to be downloaded from an online Internet store portal for computer programs and for execution on a portable mobile communication terminal such as the smartphone 1 shown. This is treated like any other “App” downloaded via an online Internet store portal for computer programs.

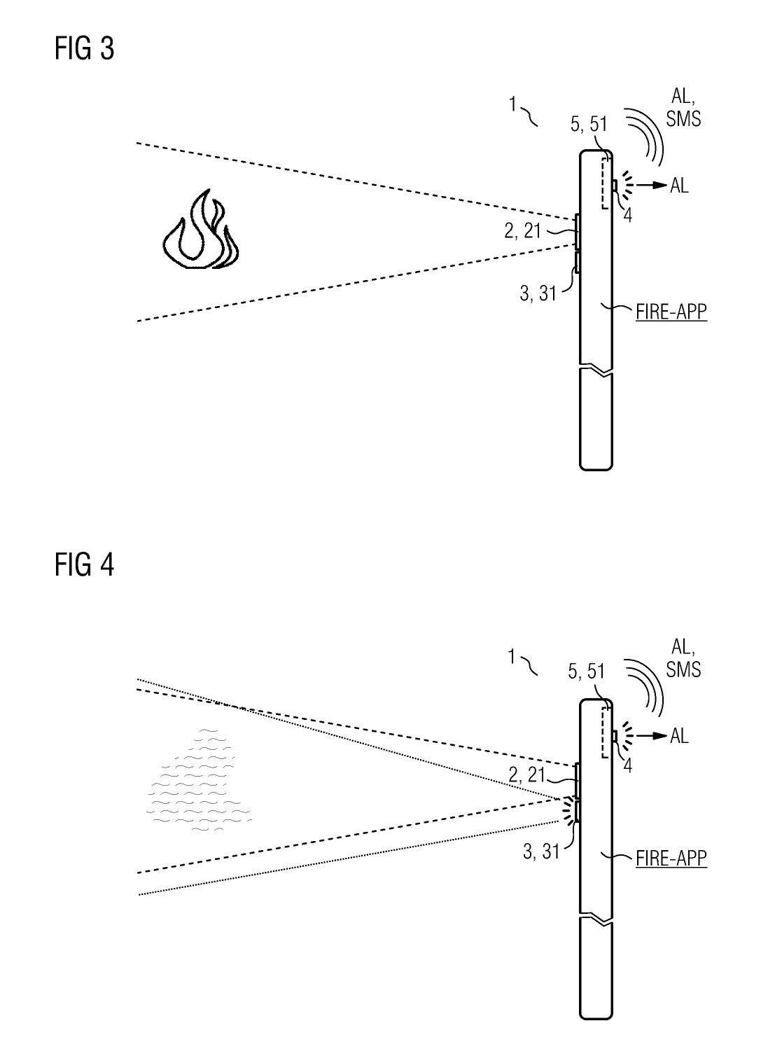

FIG. 3 shows a side view of the smartphone 1 in accordance with FIG. 1, with a camera 2, 21 directed towards an open fire. In this case the alarm AL is output via an SMS via the wireless data interface 51 and on an acoustic path via the loudspeaker 4.

FIG. 4 shows a side view of the smartphone in accordance with FIG. 1 with a camera 2, 21 directed towards smoke. In this case a flash LED 31 is activated at least from time to time for detection of smoke in order to make possible improved image quality for further processing of the video image data from the digital camera for the presence of smoke.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1. A smartphone or media player portable mobile communication terminal comprising:
a camera to record video image data;
a non-volatile data memory connected to the camera, to store applications, the applications including a fire alarm application that analyzes the video image data with respect to a characteristic of fire; and
a processor connected to the data memory, to load and execute the applications as requested by a user, the processor producing a fire signal if the characteristic of fire is detected when executing the fire application; and
an output unit connected to the processor, to output an alarm if the processor produces the fire signal.

2. The communication terminal as claimed in claim 1, wherein the fire alarm application detects an open flame by analyzing modulated information from open fire.

3. The communication terminal as claimed in claim 2, wherein the fire alarm application analyzes modulated emissions of open fire with respect of a characteristic flicker frequency and/or a characteristic color spectrum.

4. The communication terminal as claimed in claim 1, wherein the fire alarm application analyzes a moving area in the video image data by determining a direction and a size of the moving area for possible presence of smoke, as a function of at least one item of information characteristic of smoke.

5. The communication terminal as claimed in claim 4, wherein
the communication terminal further comprises a light source activated by the processor for illumination of a detection area lying in front of the camera, and
the fire application switches on the light source at specific times.

6. The communication terminal as claimed in claim 5, wherein the light source is a white illuminating LED.

7. The communication terminal as claimed in claim 5, wherein
the light source is a variable wavelength light source,
the processor analyzes the video image data for particles having a first particle size, when the light source produces light having a first wavelength, and
the processor analyzes the video image data for particles having a second particle size, when the light source produces light having a second wavelength.

8. The communication terminal as claimed in claim 1, wherein the communication terminal further comprises a data interface configured to load applications including the fire alarm application into the data memory.

9. The communication terminal as claimed in claim 8, wherein
an operating system for operating the communication terminal is stored in the data memory,
the data interface is configured for online Internet data exchange and/or online intranet data exchange,
an application store program is stored in the data memory, and
the application store program loads applications including the fire alarm application from an online Internet store portal for computer programs, via the data interface.

10. The communication terminal as claimed in claim 8, wherein the data interface is a wireless data interface based on a mobile wireless, WLAN and/or Bluetooth standard.

11. The communication terminal as claimed in claim 8, wherein the operating system is an Apple iOS operating system, an Android operating system or a Windows Phone operating system.

12. The communication terminal as claimed in claim 1, wherein the output unit outputs the alarm optically and/or acoustically.

13. The communication terminal as claimed in claim 1, wherein
the communication terminal further comprises a data interface, and
the output unit outputs the alarm via the data interface.

14. The communication terminal as claimed in claim 13, wherein the alarm is a text message output via the data interface.

15. The communication terminal as claimed in claim 1, wherein
the output unit comprises a vibration alarm that is activated electrically if the processor produces the fire signal.

16. A fire alarm application stored on a non-transitory computer readable storage medium, to cause a smartphone or media player communication terminal to perform a fire detection process after the fire alarm application is downloaded from an online Internet store portal for computer programs, the fire detection process comprising:
recording video image data;
using a processor to analyze the video image data with respect to a characteristic of fire and to produce a fire signal if the characteristic of fire is detected; and
outputting an alarm if the processor produces the fire signal.
